(19) United States
(12) Patent Application Publication
(10) Pub. No.: US 2014/0017418 A1
(43) Pub. Date: Jan. 16, 2014

(54) AQUEOUS COMPOSITION, OPTICAL FILM INCLUDING THE SAME, POLARIZING PLATE USING THE SAME, AND LIQUID CRYSTAL DISPLAY DEVICE USING THE SAME

(71) Applicant: LG CHEM, LTD., Seoul (KR)

(72) Inventors: Hwa-Sub SHIM, Daejeon (KR); Su-Young RYU, Daejeon (KR); Nam-Jeong LEE, Daejeon (KR)

(73) Assignee: LG CHEM, LTD., Seoul (KR)

(21) Appl. No.: 14/025,421

(22) Filed: Sep. 12, 2013

Related U.S. Application Data
(63) Continuation of application No. PCT/KR2013/004778, filed on May 30, 2013.

(30) Foreign Application Priority Data
May 30, 2012 (KR) 10-2012-0057581
May 30, 2013 (KR) 20-2013-0061946

(51) Int. Cl. G02F 1/1335

(52) U.S. Cl. CPC G02F 1/133528
USPC 428/1.31; 428/423.1; 428/220; 524/503

(57) ABSTRACT

The present invention relates to an aqueous primer composition 100 parts by weight of a urethane resin, 1 to 100 parts by weight of polyvinyl alcohol, 0.1 to 10 parts by weight of water dispersible particles, and a remainder of water, an optical film including the same, a polarizing plate using the same and a liquid crystal display device using the same.

### CROSS-REFERENCE TO RELATED APPLICATIONS

This application is a Continuation Bypass Application of International Patent Application No. PCT/KR2013/004778, filed May 30, 2013, and claims the benefit of Korean Patent Application Nos. 10-2012-0057581 filed on May 30, 2012, and 10-2013-0061946 filed on May 30, 2013, in the Korean Intellectual Property Office, the disclosure of which are incorporated herein by reference.

### BACKGROUND OF THE INVENTION

1. Field of the Invention

The present invention relates to an aqueous primer composition, an optical film including the same, a polarizing plate using the same, and a liquid crystal display device using the same, and more particularly, to an aqueous primer composition having good adhesiveness with regard to an acryl film and not inhibiting optical properties and durability of an optical film when applied as the optical film, an optical film including the same, a polarizing plate using the same, and a liquid crystal display device using the same.

2. Description of the Related Art

A liquid crystal display (LCD) device is a display device illuminating pixels by using a principle of selectively transmitting light in line with the change in an optical function according to the alignment of liquid crystals disposed between polarizing plates. When the polarizing plate is applied to the LCD device without a separate optical film, and when observing a screen from a slanted direction, the brightness or the contrast of the image may be markedly deteriorated or defects such as light-leakage may occur. In order to solve the problem of such defects, a method of including an optical compensation film such as a phase difference film or a viewing angle compensation film in the polarizing plate, or a method of including an optical compensation film between the polarizing plate and a liquid crystal panel, are used. As described above, the optical compensation film such as the phase difference film, the viewing angle compensation film, or the like, may be inserted between the polarizing plate and the LCD device to decrease the color change, to enlarge the viewing angle and to improve luminance of the LCD device.

Meanwhile, according to manufacturing methods, the optical compensation films may be classified as an oriented film to which anisotropy may be imparted by orienting a polymer film, and a liquid crystal film which may be obtained by coating a polymeric liquid crystal compound on a plastic base, drying, and exposing the polymeric liquid crystal compound to ultraviolet light for curing.

The oriented film and the liquid crystal film used as the optical film may have optically anisotropic properties. In this case, the optical anisotropy may be imparted to the oriented film by a method of controlling the mixing ratio of a material having a positive phase difference and a material having a negative phase difference, which may be used for forming the polymer film, and a drawing ratio of a polymer film. In addition, the liquid crystal may be classified as a disc-type liquid crystal or a rod-type liquid crystal, according to the shapes of liquid crystal molecules. Particularly, the rod-type liquid crystal may include various aligning shapes such as planar, homeotropic, tilted, splay, cholesteric alignment shapes, and the like. Thus, the imparting of optical anisotropy to the liquid crystal film may be commonly conducted by controlling the aligning shapes.

Meanwhile, a common liquid crystal film may be formed by forming an aligning layer 2 on a triacetyl cellulose (TAC) base 3, aligning the aligning layer 2 through a rubbing treatment, exposing the aligning layer 2 to polarized light, or the like, coating a polymeric liquid crystal compound on the aligning layer, drying and curing to fix and to form a liquid crystal layer 1. However, in this case, since the film including the TAC ingredient may have poor moisture resistance, the durability thereof due to a dimensional change after a long period of usage may be generated.

In order to compensate the above-described defects, attempts to apply a film of a component having a high degree of resistance to moisture and low phase difference physical properties, such as a cyclic olefin-based resin or an acryl resin have been conducted. Particularly, films having acryl components are known to have good optical properties, and good durability for a relatively low price. However, different from a TAC base, since the acryl film has a high drawing ratio and a low surface roughness, the surface thereof may be relatively dense and the penetration of a coating layer thereinto may be difficult. Further, the attachment strength of the acryl film to the alignment layer and to the liquid crystal layer may be poor. In addition, since the acryl film has a poor solvent-resistance, the acryl film may be damaged by an organic solvent included in an alignment composition. Thus, aligning properties may not be good.

Therefore, the development of techniques of manufacturing an optical film having good adhesiveness with an alignment layer and a liquid crystal layer, good solvent-resistance, and good alignment properties, even though using an acryl film as a base film, is urgent.

### SUMMARY OF THE INVENTION

An aspect of the present invention considering the above-described defects provides an aqueous primer composition capable of improving the solvent-resistance of an acryl film and the adhesiveness of an orientation layer, an optical film including the same, a polarizing plate using the same and a liquid crystal display device including the same.

According to an aspect of the present invention, there is provided an aqueous primer composition including 100 parts by weight of a urethane resin, 1 to 100 parts by weight of polyvinyl alcohol, 0.1 to 10 parts by weight of water dispersible particles; and a remainder of water.

In this case, the solid content of the aqueous primer composition may preferably be 1 to 50 parts by weight based on 100 parts by weight of the total aqueous primer composition. In addition, the weight average molecular weight of the urethane resin may be 10,000 to 200,000 in the aqueous primer composition, and the urethane resin may preferably include a carboxylic acid group. In addition, the urethane resin may be obtained by conducting a reaction of a polyol compound and an isocyanate compound.

According to another aspect of the present invention, there is provided an optical film including a primer layer formed by using the aqueous primer composition.

According to another aspect of the present invention, there is provided a polarizing plate including the optical film.

According to another aspect of the present invention, there is provided a display device including the polarizing plate.

An acryl film including a primer layer formed by using an aqueous primer composition according to the present invention, has good adhesiveness with regard to an orientation layer and good solvent-resistance, and the acryl film may be usefully used as a base film of a liquid crystal film.

In addition, when the liquid crystal film is used as a passivating film of a polarizer, good adhesiveness may be obtained between the polarizer and the acryl film when using the aqueous primer composition of the present invention. Thus, the durability of a manufactured polarizing plate may be improved without deteriorating optical properties thereof, such as light transmittance.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a cross-sectional view illustrating a structure of a common optical film; and

FIG. 2 is a cross-sectional view illustrating a structure of an optical film according to an example of the present invention.

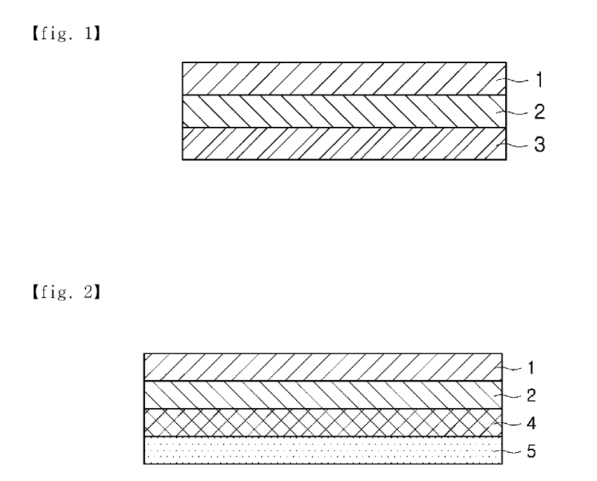

### DETAILED DESCRIPTION OF THE PREFERRED EMBODIMENT

Exemplary embodiments of the present invention will now be described in detail with reference to the accompanying drawings. The invention, however, may be embodied in various different forms, and should not be construed as being limited only to the illustrated embodiments. Rather, these example embodiments are provided so that this description will be thorough and complete, and will fully convey the scope of the present inventive concept to those skilled in the art. In the drawings, the sizes and relative sizes of layers and regions may be exaggerated for clarity.

In accordance with an aspect of the present invention, an aqueous primer composition including 100 parts by weight of a urethane resin, 1 to 100 parts by weight of polyvinyl alcohol, 0.1 to 10 parts by weight of water dispersible particles, and a remainder of water is provided. Meanwhile, the amounts of the urethane resin, the polyvinyl alcohol and the water dispersible particles represent the amounts of solid contents thereof.

In the description, the term ‘remainder’ means remaining parts by weight excluding the amounts of the urethane resin, the polyvinyl alcohol, the water dispersible particles and selectively included ingredients based on 100 parts by weight of the total aqueous primer composition. That is, after adding the urethane resin, the polyvinyl alcohol, the water dispersible particles and the selectively included ingredients, the water may be added to control the total amount of the aqueous primer composition to 100.

The aqueous primer composition is preferably water-soluble because explosion proof equipment is not necessary for use therewith.

Meanwhile, the weight average molecular weight of the urethane resin is preferably from 10,000 to 200,000. When the weight average molecular weight of the urethane resin satisfies the above-described numerical range, good adhesiveness properties may be obtained, and the synthesis of urethane may be easily conducted.

In addition, the urethane resin is preferably obtained by conducting a reaction between a polyol compound and an isocyanate compound.

In this case, any polyols including at least two hydroxyl groups may be used; however, the present invention is not limited thereto, and an appropriate polyol may be optionally used. For example, at least one selected from the group consisting of a polyester polyol, a polyether polyol and a polycarbonate diol may be used; however, the present invention is not limited thereto.

Among the polyols for obtaining the urethane resin in the aqueous primer composition in accordance with exemplary embodiments, the polyester polyol may preferably be obtained by conducting a reaction of a polybasic acid component and a polyol component.

The polybasic acid component for obtaining the polyester polyol may be at least one selected from the group consisting of an aromatic dicaroboxylic acid such as ortho-phthalic acid, isophthalic acid, terephthalic acid, 1,4-naphthalene dicarboxylic acid, 2,5-naphthalene dicaroboxylic acid, 2,6-naphthalene dicaroboxylic acid, biphenyl dicarboxylic acid, tetrahydrophthalic acid, and the like; an aliphatic dicarboxylic acid such as oxalic acid, succinic acid, malonic acid, glutaric acid, adipic acid, pimellic acid, suberic acid, azelaic acid, sebacic acid, linoleic acid, maleic acid, fumaric acid, mesaconic acid, itaconic acid, and the like; an alicyclic dicarboxylic acid such as hexahydrophthalic acid, tetrahydrophthalic acid, 1,3-cyclohexanedicarboxylic acid, 1,4-cyclohexanedicarboxylic acid, and the like; a reactive derivative such as an acid anhydride thereof, an alkyl ester thereof, an acid halide thereof, and the like; however, the present invention is not limited thereto.

In addition, the polyol component for obtaining the polyester polyol may be at least one selected from the group consisting of ethylene glycol, 1,2-propandiol, 1,3-propanediol, 1,3-butanediol, 1,4-butanediol, neopentyl glycol, pentanediol, 1,6-hexanediol, 1,8-octanediol, 1,10-decanediol, 4,4′-dihydroxyphenyl propane, 4,4′-dihydroxymethyl methane, diethylene glycol, triethylene glycol, polyethylene glycol, dipropylene glycol, polypropylene glycol, 1,4-cyclohexane dimethanol, 1,4-cyclohexanediol, bisphenol A, bisphenol F, glycerine, 1,1,1-trimethylolpropane, 1,2,5-hexatriol, pentaerythritol, glucose, sucrose and sorbitol; however, the present invention is not limited thereto.

Among the polyol for obtaining the urethane resin in the aqueous primer composition in accordance with exemplary embodiments, the polyether polyol may preferably be obtained by adding alkylene oxide into a poly alcohol through conducting a ring opening polymerization. The poly alcohol may be at least one selected from the group consisting of ethylene glycol, diethylene glycol, propylene glycol, dipropylene glycol, glycerin and trimethylol propane; however, the present invention is not limited thereto.

Among the polyol for obtaining the urethane resin in the aqueous primer composition in accordance with exemplary embodiments, the polycarbonate polyol may be at least one selected from the group consisting of poly(hexamethylene carbonate)glycol and poly(cyclohexane carbonate)glycol; however, the present invention is not limited thereto.

Meanwhile, the isocyanate may be at least one selected from the group consisting of toluene diisocyanate (TDI), 4,4-diphenylmethane diisocyanate (MDI), 1,5-naphthalene diisocyanate (NDI), toluidine diisocyanate (TODI), hexamethylene diisocyanate (HMDI), isophorone diisocyanate (IPDI), p-phenylene diisocyanate, and 1,4-diisocyanate and xylene diisocyanate (XDI); however, the present invention is not limited thereto.

The urethane resin in the aqueous primer composition in accordance with exemplary embodiments may include a carboxylic acid group. In this case, the carboxylic acid group may form an anion part while preparing a water dispersible urethane to be dispersed in water and to increase the adhesiveness onto a polarizer.

The urethane resin including the carboxyl group as described above, may be obtained by additionally conducting a reaction by using a chain extender including a free carboxyl group, during conducting the reaction between the polyol and the isocyanate. In this case, the chain extender including the carboxyl group may include, for example, dihydroxycarboxylic acid, dihydroxysuccinic acid, and the like; however, the present invention is not limited thereto.

In addition, the dihydroxycarboxylic acid may be used by combining at least one selected from the group consisting of dialkyol alkanoic acid such as dimethylol alkanoic acid (dimethylol acetic acid, dimethylol butanoic acid, dimethylol propionic acid, dimethylol butyric acid and dimethylol pentanoic acid); however, the present invention is not limited thereto.

Meanwhile, a method of preparing the urethane resin may include an optional and appropriate method. For example, a one shot method by which each of the components may react simultaneously, or a multi-step method by which each of the components may react in a step-by-step manner. When the urethane resin includes the carboxyl group, the multi-step method may be preferred to easily introduce the carboxyl group. Further, an optional and appropriate urethane reaction catalyst may be used during the preparation of the urethane resin.

When preparing the urethane resin, another polyol, another chain extender, or a combination thereof may be additionally used for conducting the reaction.

In this case, any polyols including at least three hydroxyl groups may be used as the another polyol without limitation, and may include sorbitol, glycerin, trimethylolethane, trimethylolpropane, pentaerythritol, or the like.

In addition, the another chain extender may include, for example, glycol compounds such as ethylene glycol, diethylene glycol, triethylene glycol, 1,3-propanediol, 1,3-butanediol, 1,4-butanediol, neopentyl glycol, pentanediol, 1,6-hexanediol, propylene glycol, and the like; aliphatic diamine compounds such as ethylenediamine, propylenediamine, hexamethylenediamine, 1,4-butanediamine, aminoethyl alkanolamine, and the like; alicyclic diamine compounds such as isophoronediamine, 4,4′-dicyclohexyl methanediamine, and the like; aromatic diamine compounds such as xylylene diamine, tolylene diamine, and the like; however, the present invention is not limited thereto.

Meanwhile, during preparing the urethane resin, a neutralizing agent may be used to improve the stability of the urethane resin in water. The neutralizing agent may be at least one selected from the group consisting of ammonia, N-methyl morpholine, triethylamine, dimethyl ethanolamine, methyldialkanolamine, triethanolalkyne, morpholine, tripropylamine, ethanolamine, and triisopropanolamine; however, the present invention is not limited thereto.

In addition, when preparing the urethane resin, an organic solvent inert to the isocyanate and compatible with water may preferably be used. In this case, the organic solvent may be at least one selected from the group consisting of an ester solvent such as ethyl acetate, ethyl cellosolve acetate, and the like; a ketone solvent such as acetone, methyl ethyl ketone, methyl isobutyl ketone, and the like; and an ether solvent such as dioxane tetrahydrofurane, and the like; however, the present invention is not limited thereto.

Then, the weight average molecular weight of the polyvinyl alcohol is preferably from 2,000 to 40,000. When the weight average molecular weight of the polyvinyl alcohol satisfies the above-described numerical range, the solvent-resistance may be improved, and viscosity may not be increased. Thus, a coating process and a drying process may be easily conducted.

In addition, the amount of the polyvinyl alcohol may be 1 to 100 parts by weight, and preferably may be 10 to 100 parts by weight, and more preferably may be 50 to 100 parts by weight based on 100 parts by weight of the urethane resin. When the amount of the polyvinyl alcohol satisfies the above-described numerical range, the solvent-resistance may be improved, and the adhesiveness with acryl may be good. In addition, since the amount of the polyvinyl alcohol is not large, the viscosity thereof may be constant, and leveling properties during conducting the coating process may be good.

The polyvinyl alcohol is used to improve the solvent-resistance, and commonly used compounds in this field may be used, without limitation. For example, Gohsefimer Z-100®, Z-200®, Z-200H®, Z-210®, Z-220®, Z-320®, or the like available from Japan Synthesis Chemistry Co., may be used.

Then, the particles used in the exemplary embodiments may include optional and appropriate particles. Preferably, water dispersible particles may be used. Particularly, both of inorganic particles and/or organic particles may be used.

In this case, the inorganic particles may be inorganic oxides such as silica, titania, alumina, zirconia, antimony, or the like; however, the present invention is not limited thereto. In addition, the organic particles may include a silicon-based resin, a fluorine-based resin, a (meth)acryl-based resin, a cross-linked polyvinyl alcohol, a melamine-based resin, or the like; however, the present invention is not limited thereto.

In particular, the water dispersible particles in the aqueous primer composition in accordance with exemplary embodiments may be silica. The silica has good blocking restraining properties, has good transparency, and does not generate haze. In addition, coloring is not generated, and thus, effects onto optical properties of a polarizing plate are very small. In addition, since silica has good dispersibility and dispersion stability with respect to the aqueous primer composition, workability during forming a primer layer may be good.

Meanwhile, an average diameter of the water dispersible particles, that is, an average primary particle diameter may be, for example, from 10 nm to 200 nm, from 15 nm to 150 nm, or from 20 nm to 100 nm. When the average diameter of the water dispersible particles satisfies the above-described numerical range, the occurrence of coagulation and precipitation of the water dispersible particles in the aqueous primer solution may be decreased, and the stability of the solution may be good. Thus, the dispersion of the water dispersible particles in the aqueous primer solution may be uniformly attained. Therefore, the agglomeration of the particles may be prevented and the light in visible region may be scattered to prevent the increase of the haze.

That is, by using the water dispersible particles having a particle diameter in the above-described range, an embossing structure may be appropriately formed on the surface of the primer layer. In particular, the frictional force at the contacting surface between the acryl film and the primer layer and/or between the primer layers, may be effectively decreased. As a result, when a film on which the primer layer is formed, is wrapped, blocking restraining power may become very good.

Since the primer composition in accordance with exemplary embodiments is aqueous, the water dispersible particles are preferably mixed as a water dispersant. In particular, when silica is employed as the water dispersible particles, colloidal silica is preferably used. Any purchasable colloidal silica in the field, for example, Snowtex series of Nissan Chemical Industries., Ltd., AEROSIL series of Airproduct Co., epostar series or soliosta RA series of Japan Catalyst Co., LSH series of Ranco Co., or the like may be used.

In this case, the amount of the water dispersible particles may be 0.1 to 10 parts by weight or 0.1 to 8 parts by weight based on 100 parts by weight of the urethane resin. When the amount of the water dispersible particles satisfies the above-described numerical range, the generation of the blocking may be remarkably decreased, and the haze may be decreased to form a film having good optical properties.

Then, the solid content of the aqueous primer composition in accordance with exemplary embodiments may not be specifically limited. However, the solid content may be, for example, 1 to 50 parts by weight, preferably, 5 to 30 parts by weight, and more preferably, 10 to 20 parts by weight based on 100 parts by weight of the aqueous primer composition. When the solid content in the aqueous primer composition in accordance with exemplary embodiments satisfies the above-described numerical range, the adhesiveness may be improved, and the viscosity may not be high. Thus, the leveling during conducting a coating process may be good and the time necessary for drying may be short. In this case, the solid content means the solid content of the total aqueous primer composition.

In accordance with another aspect of the present invention, an optical film including a primer layer formed by using the aqueous primer composition on at least one side of an acryl film may be provided.

A film conducting optical function is commonly called the optical film in exemplary embodiments. The optical film may include a transparent film of narrow range having light transmittance of 80% or above and may include an optical film having the light transmittance of 50% or less when the film is for conducting a specific optical function such as a polarizing plate.

The acryl film useful in exemplary embodiments may have a single layer or have a stacked structure of two or more layers.

More particularly, the acryl film may include a (meth)acrylate resin. A film including the (meth)acrylate resin may be obtained by molding a material containing, for example, the (meth)acrylate resin as a main component by means of extrusion molding.

In addition, the (meth)acrylate resin includes a resin including a (meth)acrylate unit as a main component, and includes a homopolymer resin including the (meth)acrylate unit as well as a copolymer resin obtained by copolymerizing the (meth)acrylate unit with other monomer unit, and a blended resin obtained by blending the (meth)acrylate resin and other resin.

In this case, the (meth)acrylate unit may be, for example, an alkyl(meth)acrylate unit. Here, the alkyl(meth)acrylate unit means both of an alkyl acrylate unit and an alkyl methacrylate unit. The alkyl group of the alkyl(meth)acrylate unit preferably includes 1 to 10 carbon atoms, and more preferably, includes 1 to 4 carbon atoms.

Meanwhile, the monomer unit capable of forming a copolymer with the (meth)acrylate unit includes an aromatic vinyl unit, a hetero cycle unit having 3 to 6 members and substituted with a carbonyl group, an acrylic acid unit, a glycidyl unit, and the like.

The aromatic vinyl unit may be a derived unit from at least one monomer selected from the group consisting of, for example, styrene, α-methyl styrene, 3-methyl styrene, 4-methyl styrene, 2,4-dimethyl styrene, 2,5-dimethyl styrene, 2-methyl-4-chlorostyrene, 2,4,6-trimethyl styrene, cis-β-methyl styrene, trans-β-methyl styrene, 4-methyl-α-methyl styrene, 4-fluoro-α-methyl styrene, 4-chloro-α-methyl styrene, 4-bromo-α-methyl styrene, 4-t-butyl styrene, 2-fluorostyrene, 3-fluorostyrene, 4-fluorostyrene, 2,4-difluororostyrene, 2,3,4,5,6-pentafluorostyrene, 2-chlorostyrene, 3-chlorostyrene, 4-chlorostyrene, 2,4-dichlorostyrene, 2,6-dichlorostyrene, octachlorostyrene, 2-bromostyrene, 3-bromostyrene, 4-bromostyrene, 2,4-dibromostyrene, α-bromostyrene, β-bromostyrene, 2-hydroxystyrene and 4-hydroxystyrene; however, the present invention is not limited thereto. In particular, the derived unit from the styrene or the α-methyl styrene among the above-described units may be preferred.

Meanwhile, the hetero cycle unit of 3 to 6 members substituted with a carbonyl group may be a derived unit from the monomers such as a lactone cycle, a glutaric acid anhydride, glutarimide, maleic acid anhydride, maleic imide, and the like.

The resin capable of being blended with the (meth)acrylate resin may be a phenoxy resin, a polycarbonate resin, and the like; however, the present invention is not limited thereto.

Meanwhile, a method of forming the (meth)acrylate resin film is not specifically limited. For example, the (meth)acrylate resin, other polymers, additives, and the like may be sufficiently mixed by an appropriate mixing method to form a thermoplastic resin composition. Then, the composition may be molded into a film. Alternatively, the (meth)acrylate resin, other polymers, additives, and the like may be prepared as separate solutions, and mixed to obtain a homogeneous mixture solution. Then, the mixture solution may be molded into a film.

In this case, the thermoplastic resin composition may be prepared by pre-blending the film materials by means of an appropriate mixer such as an omni mixer, and the like, and then pressure mulling the thus obtained mixture. The mixer used for the pressure mulling may be any appropriate mixer such as a uniaxial extruder, a biaxial extruder, a pressurizing kneader, and the like; however, the present invention is not limited thereto.

Then, the method of forming the film may include any appropriate film forming methods, for example, a solution casting method (a solution kneading method), a melt extrusion method, a calendar method, a compression molding method, or the like. Among the above-described film forming methods, the solution casting method (the solution kneading method) or the melt extrusion method may be preferred.

Solvents used in the solution casting method (the solution kneading method) includes, for example, an aromatic hydrocarbon such as benzene, toluene, xylene, and the like; an aliphatic hydrocarbon such as cyclohexane, decaline, and the like; an ester such as ethyl acetate, butyl acetate, and the like; a ketone such as acetone, methyl ethyl ketone, methyl isobutyl ketone, and the like; an alcohol such as methanol, ethanol, isopropanol, butanol, isobutanol, methyl cellosolve, ethyl cellosolve, butyl cellosolve, and the like; an ether such as tetrahydrofuran, dioxane, and the like; a halogenated hydrocarbon such as dichloromethane, chloroform, carbon tetrachloride, and the like; dimethyl formamide; dimethyl sulfoxide, and the like. The solvents may be used alone or in combination of two or more.

As an apparatus for conducting the solution casting method (the solution kneading method), for example, a drum type casting machine, a band type casting machine, a spin coater, and the like may be used. The melt extrusion method may include, for example, a T die method, an inflation method, and the like. The molding temperature may preferably be from 150° C. to 350° C., and more preferably, from 200° C. to 300° C.

When the film is formed by using the T die method, a T die may be installed on the leading edge part of a known uniaxial extruder or a biaxial extruder, and then, the extruded film having a film shape may be wrapped to obtain a film having a roll shape. In this case, the extruded film may be uniaxially oriented by applying an elongation in an extruding direction by appropriately controlling the temperature of the wrapping roll. Alternatively, the extruded film may be simultaneously biaxially oriented or successively biaxially oriented by applying an elongation in a vertical direction to the extruding direction.

Meanwhile, the acryl film may be one of a non-oriented film or an oriented film. The oriented film may be a uniaxially oriented film or a biaxially oriented film, and the biaxially oriented film may be a simultaneously biaxially oriented film or a successively biaxially oriented film. The biaxially oriented film may have improved mechanical strength and have improved film properties. The increase of the phase difference of the acryl film may be restrained, and optical isotropy may be maintained during the elongation by mixing other thermoplastic resin.

In this case, the elongation temperature may preferably be in a range near the glass transition temperature of the thermoplastic resin composition which is the raw material of the film, more preferably from (glass transition temperature−30° C.) to (glass transition temperature+100° C.), and more preferably from (glass transition temperature−20° C.) to (glass transition temperature+80° C.). When the elongation temperature is less than (glass transition temperature−30° C.), a sufficient drawing ratio may not be obtained. On the contrary, when the elongation temperature exceeds (glass transition temperature+100° C.), and the flow of the resin composition may be generated, and a stable elongation may not be conducted.

In addition, the drawing ratio defined by an area ratio may preferably be 1.1 to 25 times, and may be more preferably, 1.3 to 10 times. When the drawing ratio is less than 1.1, the improvement of toughness accompanied with the elongation may not be obtained. When the drawing ratio exceeds 25 times, a corresponding effect in proportion to the increase of the drawing ratio may not be obtained.

In addition, the elongation rate is preferably 10 to 20,000%/min, and is more preferably 100 to 10,000%/min in one direction. When the elongation rate is less than 10%/min, a somewhat long time may be necessary to obtain a sufficient drawing ratio, and production cost may be increased. When the elongation rate exceeds 20,000%/min, the breaking of the oriented film may be generated.

Meanwhile, the acryl film may be heat treated (annealed) after the elongation to stabilize the optical isotropy or the mechanical properties thereof. The conditions of the heat treatment may be any appropriate conditions known in this art; however, the present invention is not limited thereto.

Then, the surface of the acryl film may be treated to improve adhesiveness as occasion demands. For example, at least one surface of the acryl film may be surface treated by at least one selected from the group consisting of an alkaline treatment, a corona treatment and a plasma treatment.

The primer layer is formed by the aqueous primer composition in accordance with exemplary embodiments, and may be formed by coating the aqueous primer composition on at least one surface of the acryl film. Since detailed description on the aqueous primer composition is the same as described above, particular explanation will be omitted.

Meanwhile, the primer layer may be formed by a forming method of a coating layer commonly used in this field such as wire coating, bar coating, spin coating, and the like. The method of forming the primer layer is not particularly limited.

In the optical film of the present invention, the primer layer may be formed at only one surface of the acryl film or at both surfaces thereof. According to the researches by the present inventors, the aqueous primer composition according to the present invention may increase the adhesiveness between an orientation layer and the acryl film, and the adhesiveness between a polarizer and the acryl film. Thus, when the primer layer is formed by using the aqueous primer composition on both surfaces of the acryl film, both of the adhesiveness between the polarizer and the acryl film, and the adhesiveness between the acryl film and the orientation layer may be increased.

In the optical film of the present invention, as illustrated in FIG. 2, an orientation layer 2 and a liquid crystal layer 1 may be additionally included on a primer layer 4 formed on at least one surface of an acryl film 5.

In this case, the orientation layer may be formed by coating various compositions for the orientation layer known in this field, for example, a composition for an optical orientation layer, or a composition for a rubbing orientation layer, on the primer layer, and then, conducting a rubbing treatment or a polarized light exposing treatment for orientation. The composition for the orientation layer or the method of forming the orientation layer applicable in the present invention may not be limited in particular, and various compositions for the orientation layer and various methods for forming the orientation layer known in this art may be used without limitation.

In this case, the coating of the composition for the orientation layer may be conducted by well known methods in this art such as wire coating, bar coating, spin coating, and the like.

After coating the composition for the orientation layer, a drying process to remove remaining solvent may be conducted. The drying process may be conducted at 70° C. to 150° C. for at least 30 seconds. The drying temperature and the drying time may not be limited in particular, however, the orientation coating layer may be sufficiently dried without inducing the deformation of a base when satisfying the above-described conditions.

As for the orientation treatment, a rubbing orientation, an optical orientation, or the like may be appropriately used according to the kind of the orientation layer used. In order to increase the orientation properties, both of the rubbing orientation and the optical orientation may be used as occasion demands. In this case, the rubbing orientation may be conducted by rubbing the surface of the orientation layer using a cloth, and the optical orientation may be conducted by disposing a polarizing plate between the orientation layer and a light source to expose the orientation layer to polarized ultraviolet light. In this case, the exposure to the ultraviolet light may be conducted in the atmosphere or in an oxygen blocked nitrogen atmosphere to increase reaction efficiency. In general, a medium pressure or a high pressure mercury ultraviolet lamp or a metal halide lamp having the intensity of 80 w/cm or above, may be used.

Meanwhile, in the present invention, a composition for the orientation layer including a photo reactive polymer, a multifunctional monomer, an initiator and a solvent may be used; however, the present invention is not limited thereto. The composition for the orientation layer may further include a cross-linking agent as occasion demands. More particularly, the composition for the orientation layer in accordance with exemplary embodiments may include 0.05 to 10 parts by weight of the multifunctional monomer, 0.05 to 10 parts by weight of the photo reactive polymer, 0.01 to 5 parts by weight of the initiator, and a remainder of the solvent based on 100 parts by weight of the composition for the orientation layer; however, the present invention is not limited thereto. The composition may further include 0.01 to 2 parts by weight of the cross-linking agent as occasion demands.

As for the multifunctional monomer, a mixed multifunctional monomer obtained by mixing a multifunctional triazine monomer and a multifunctional acryl monomer may be used. The mixing ratio of the multifunctional triazine monomer and the multifunctional acryl monomer is not specifically limited in the mixture of the multifunctional triazine monomer and the multifunctional acryl monomer. The mixed multifunctional monomer including an optional ratio of the two components may be used as long as both of the multifunctional triazine monomer and the multifunctional acryl monomer are used.

In addition, the multifunctional triazine monomer may be at least one selected from the group consisting of, for example, 1,3,5-triallyl-1,3,5-triazinane-2,4,6-trion, 1,3,5-triacryloyl-1,3,5-triazinane, 1,3,5-tris(2-oxyranylmethyl)-1,3,5-triazinane-2,4,6-trion, 2-{3,5-bis[2-(acryloyloxy)ethyl]-2,4,6-trioxo-1,3,5-triazin ane-1-yl}-ethyl acrylate, and 3-(3-allyl-5-(2-cyano-ethyl)-2,4,6-trioxo-(1,3,5)triazinane-1-yl)-propionitrile; however, the present invention is not limited thereto.

Further, the multifunctional acryl monomer may be at least one selected from the group consisting of, for example, triacrylate (particularly, pentaerythritoltriacrylate, PETA), tetraacrylate (particularly, pentaerythritol tetraacrylate, PETTA), and hexaacrylate (particularly, dipentaerythritol hexaacrylate, DPHA); however, the present invention is not limited thereto. The amount of the mixed multifunctional monomer may be 0.05 to 10 parts by weight based on the composition of the optical orientation layer. When the amount of the multifunctional acryl monomer satisfies the above-described range, an interlayer adhesiveness between the optical orientation layer and the base film may be good, and the separation of the optical orientation layer may be prevented. In addition, good orientation properties may be accomplished.

The photo reactive polymer may be a norbornene-based photo reactive polymer including, for example, a cinnamate group. In this case, the norbornene-based photo reactive polymer including the cinnamate group may include at least one selected from the group consisting of, for example, polynorbornene cinnamate, polynorbornene alkoxycinnamate (in which, the alkoxy group includes 1 to 20 carbon atoms), polynorbornene allyloyloxycinnamate, polynorbornene fluorocinnamate, polynorbornene chlorocinnamate and polynorbornene dicinnamate; however, the present invention is not limited thereto. In addition, the amount of the photo reactive polymer may be 0.05 to 10 parts by weight, 1 to 10 parts by weight, or 0.1 to 10 parts by weight, based on the composition of the optical orientation layer. When the amount of the photo reactive polymer satisfies the above-described numerical range, an optical orientation layer having good orientation properties may be obtained.

Any photo initiators that may induce a radical reaction may be used, and a water-soluble photo initiator is preferred. For example, IRGACURE 2959 (2-hydroxy-1-[4-(2-hydroxyethoxy)phenyl]-2-methyl-1-propano ne), IRGACURE 500 (1-hydroxy-cyclohexyl-phenyl-ketone+benzophenone), IRGACURE 754 (oxyphenyl-acetic acid 2-[2-oxo-2-phenyl-acetoxy-ethoxy]-ethyl ester and oxyphenyl-acetic 2[2-hydroxyethoxy]-ethyl ester), or IRGACURE OXE02 (1-(1-6-benzoyl-9-ethyl-9H-carbazol-3-yl)ethylideneaminooxy) ethanone, available from Ciba-Geigy Co., may be used; however, the present invention is not limited thereto. The amount of the photo initiator is 0.01 to 5 parts by weight based on the composition for the optical orientation layer. When the amount of the photo initiator satisfies the above-described numerical range, a cross-linking reaction effect due to the multifunctional monomer may be expected, and the orientation properties of the liquid crystal may be increased.

The solvent may include any solvents capable of dissolving the multifunctional monomer and the photo reactive polymer, and the kind of the solvent may not be limited in particular. For example, the solvent may include, for example, an organic solvent such as a halogenated hydrocarbon including chloroform, tetrachloroethane, trichloroethylene, tetrachloroethylene, chlorobenzene, and the like; an aromatic hydrocarbon including benzene, toluene, xylene, methoxybenzene, 1,2-dimethoxybenzene, and the like; a ketone including acetone, methyl ethyl ketone, cyclohexanone, cyclopentanone, and the like; an alcohol including isopropyl alcohol, n-butanol, and the like; a cellosolve including methyl cellosolve, ethyl cellosolve, butyl cellosolve, and the like, water, or a mixture thereof.

The cross-linking agent may include an aldehyde compound, a dialdehyde compound, an isocyanate compound, and the like; however, the present invention is not limited thereto. Here, the aldehyde compound or the dialdehyde compound may include, for example, acrylaldehyde, oxalaldehyde, 2-methyl acrylaldehyde, 2-oxopropanal, glutaraldehyde, and the like; however, the present invention is not limited thereto. In addition, the isocyanate compound may include, for example, 2-isocyanatoethyl 2-methylacrylate, 1,4-diisocyanatobutane, 1,4-diisocyanatobenzene, 1,3-diisocyanatobenzene, and the like; however, the present invention is not limited thereto. The cross-linking agent may be used alone or as a mixture of two or more thereof.

In addition, the amount of the cross-linking agent may be 0 to 2 parts by weight, and preferably may be 0.01 to 2 parts by weight, based on the total amount of the composition for the orientation layer. When the amount of the cross-linking agent satisfies the above-described numerical range, cross-linking reaction may be sufficiently induced. Thus, solution stability may be good, and uniform coating properties may be obtained. Particularly, the orientation properties of liquid crystals after conducting an orientation treatment may be good.

Then, the liquid crystal layer may be formed by a method for forming a liquid crystal layer well known in this art. For example, a liquid crystal compound solution is coated on a rubbing treated orientation layer, and fixing the liquid crystal compound solution.

The coating of the liquid crystal compound solution may be conducted by well known common methods in this art, such as a wire coating, a bar coating, a spin coating, and the like.

After coating the liquid crystal compound solution, a drying process to remove remaining solvents may be conducted. In this case, the drying process may be conducted at 25° C. to 120° C. for at least 1 minute. The drying temperature or the drying time may not be specifically limited, however, the above-described drying conditions may be preferred when considering the improvement of the orientation properties of liquid crystals and the prevention of the generation of defects.

The fixing may be conducted to fix the orientation of the liquid crystals. For example, the fixing may be conducted by polymerizing and curing liquid crystal compounds through the exposure to ultraviolet light. In this case, the exposure to the ultraviolet light may be conducted in the atmosphere or in an oxygen blocked nitrogen atmosphere to increase reaction efficiency. In general, a medium pressure or a high pressure mercury ultraviolet lamp or a metal halide lamp having an intensity of 80 w/cm or above, may be used. A cold mirror or another cooling means may be installed between a base and an ultraviolet lamp so that the surface temperature of a liquid crystal layer may be within a temperature range having a liquid crystal state while exposing to the ultraviolet.

Meanwhile, as for the liquid crystal compound solution, any liquid crystal compound solutions commonly used in this art may be used; however, the present invention is not limited thereto. For example, a liquid crystal compound solution obtained by dissolving the polymeric liquid crystal compound and the photo initiator in an organic solvent may be used.

In this case, as the polymeric liquid crystal compound, a material having an acrylate group polymerizable by photo reaction and well known in this art may be used; however, the present invention is not limited thereto. For example, a low molecular weight liquid crystal illustrating nematic or cholesteric liquid crystal phase at room temperature or at a high temperature such as cyanobiphenyl, cyanophenyl cyclohexane, cyanophenyl ester, benzoic acid phenyl ester, and phenylpyrimidine acrylate may be used. These materials may be used alone or as a mixture of two or more thereof. The amount of the polymeric liquid crystal compound in the liquid crystal compound solution is not specifically limited, and may be 5 to 70 parts by weight, and preferably may be 5 to 50 parts by weight based on 100 parts by weight of the liquid crystal compound solution. When the amount of the polymeric liquid crystal compound satisfies the above-described numerical range, the generation of stains may be remarkably decreased. In addition, the precipitation of the polymeric liquid crystal compound due to the lack of the solvent may be prevented.

In addition, any photo initiators well known in this art may be used; however, the present invention is not limited thereto. For example, IRGACURE 907, and the like may be used. The amount of the photo initiator may preferably be 3 to 10 parts by weight based on 100 parts by weight of the polymeric liquid crystal compound included in the liquid crystal compound solution. When the amount of the photo initiator satisfies the above-described numerical range, sufficient curing of the liquid crystal compound solution may be possible by the exposure thereof to ultraviolet light, and the change of the liquid crystal orientation due to the photo initiator may be prevented.

In addition, besides the photo initiator, the liquid crystal compound solution may further include a chiral agent, a surfactant, a polymeric monomer, a polymer, or the like as occasion demands as long as the liquid crystal orientation is not inhibited.

Meanwhile, the organic solvent used for the preparation of the liquid crystal compound solution may include, for example, a halogenated hydrocarbon including chloroform, tetrachloroethane, trichloroethylene, tetrachloroethylene, chlorobenzene, and the like; an aromatic hydrocarbon including benzene, toluene, xylene, methoxybenzene, 1,2-dimethoxybenzene, and the like; a ketone including acetone, methyl ethyl ketone, cyclohexanone, cyclopentanone, and the like; an alcohol including isopropyl alcohol, n-butanol, and the like; a cellosolve including methyl cellosolve, ethyl cellosolve, butyl cellosolve, and the like; however, the present invention is not limited thereto. These compounds may be used alone or as a mixture of two or more thereof.

In accordance with a third aspect of the present invention, a polarizing plate including the optical film is provided. The polarizing plate according to the present invention may include, for example, a polarizer, and the optical film of the present invention disposed at least one surface of the polarizer. More particularly, the polarizing plate according to the present invention may include the optical film obtained by stacking an acryl film, a primer layer, an orientation layer and a liquid crystal layer one by one on at least one surface of the polarizer.

The thus obtained polarizing plate according to the present invention may preferably have a light transmittance of from 35% to 45%, and polarizing degree of 98% or above.

In accordance with a fourth aspect of the present invention, a display device including the polarizing plate is provided.

The display device may include a liquid crystal display device and any kinds of devices including the above-described optical film or the polarizing plate; however, the present invention is not limited thereto. The display device has the same constitution known in the art except for including a primer layer formed by using the aqueous primer composition in accordance with the present invention. For example, the display device may be a liquid crystal display device including a liquid crystal cell; polarizing plates of the present invention provided at both surfaces of the liquid crystal cell; and a back light unit.

### PREFERRED EMBODIMENT OF THE PRESENT INVENTION

### Example 1

50 g of a urethane resin emulsion (CK-PUD-F, Chokwang-poly urethane dispersion, an emulsion including 10% solid content) and 111 g of an aqueous polyvinyl alcohol solution (Japan Synthesis Chemistry Z200, an aqueous solution including 4.5% solid content), and 0.5 g of colloidal silica (Ranco Co., an aqueous solution including 20% solid content), were mixed to prepare an aqueous primer composition in which the solid content ratio of the urethane resin and the polyvinyl alcohol was 1:1. Then, the aqueous primer composition was coated on a corona treated acryl film (LG Chemistry, GP-film) by a #9 bar to a thickness of 1,000 nm. After the coating, a drying process was conducted at 100° C. for 5 minutes to obtain an acryl film including a primer layer formed thereon.

Then, 2 parts by weight, 2 parts by weight and 0.5 parts by weight of 5-norbornene-2-methyl-(4-methoxy cinnamate) as a photo reactive polymer, dipentaerythrithol hexaacrylate as a multifunctional monomer, and IRGACURE OXE02 (Swiss, Ciba-Geigy Co.) as a photo initiator, were dissolved in cyclopentanone to prepare a composition of an optical orientation layer.

Then, the composition for the optical orientation layer was coated on the primer layer of the acryl film by a wire bar to a thickness of 100 nm after drying. A drying process was conducted by hot air in a drying oven of 70° C. for 2 minutes. Then, an orientation treatment was conducted by using a high pressure mercury lamp having an intensity of 80 w/cm, as a light source and interposing a wire grid polarizing plate by Moxtek Co., between the light source and an orientation layer to emit polarized ultraviolet light, and an exposing process was conducted once at a 3 m/minute rate. The composition was cured by exposure to the ultraviolet light, and a rubbing treatment was conducted to impart orientation properties onto the surface of the cured orientation layer to complete an orientation layer.

Then, a polymeric liquid crystal compound solution prepared by dissolving a solid content of 95 parts by weight of A-PLATE (Merck Co., a liquid crystal mixture for planar orientation including cyanobiphenyl, cyanophenyl cyclohexane and cyanophenyl ester acrylates of Merck Co.) and 5 parts by weight of IRGACURE 907 (Swiss, Ciba-Geigy Co.) as a photo initiator in toluene so that the solid content was 25 parts by weight based on 100 parts by weight of the total solution, was coated on the orientation layer to a thickness of 1 μm after drying, hot air dried in a drying oven of 60° C. for 2 minutes, and cured by exposing to nonpolarized ultraviolet by using a high pressure mercury lamp having an intensity of 80 w/cm to obtain a liquid crystal layer.

### Example 2

An optical film was manufactured by conducting the same process as described in Example 1 except that the aqueous primer composition was coated by a #5 bar to a thickness of 500 nm.

### Example 3

An optical film was manufactured by conducting the same process as described in Example 1 except that the aqueous primer composition was coated by a #3 bar to a thickness of 200 nm.

### Example 4

An optical film was manufactured by conducting the same process as described in Example 1 except that the primer layer was formed by using an aqueous primer composition in which the solid content ratio of the urethane resin and the polyvinyl alcohol was controlled to 1:0.5.

### Example 5

An optical film was manufactured by conducting the same process as described in Example 1 except that the primer layer was formed by using an aqueous primer composition in which the solid content ratio of the urethane resin and the polyvinyl alcohol was controlled to 1:0.1.

### Comparative Example 1

An optical film was manufactured by conducting the same process as described in Example 1 except that the primer layer was formed by using an aqueous primer composition excluding the polyvinyl alcohol.

### Comparative Example 2

An optical film was manufactured by conducting the same process as described in Example 1 except that the primer layer was formed by using an aqueous primer composition excluding the urethane resin.

### Comparative Example 3

An optical film was manufactured by conducting the same process as described in Example 1 except that the primer layer was formed by using an aqueous primer composition in which the solid content ratio of the urethane resin and the polyvinyl alcohol was controlled to 1:4.

### EXPERIMENTS

### 1. Adhesiveness

The adhesiveness between an acryl base and an orientation layer, and between the orientation layer and a liquid crystal film was evaluated by a cross-cut test method regulated in ASTM. The surface of a liquid crystal film was cross-cut by 1 mm distance into line shapes of a checkerboard by using a knife. Then, a cellophane adhesive tape was attached on the cross-cut and then detached and observed whether the liquid crystal film was an attached state or a detached state to evaluate the adhesiveness. The results are illustrated in following Table 1. O denotes a complete attachment, X denotes partial separation or complete separation.

### 2. Orientation Properties

The orientation properties of the liquid crystal layer formed on the optical orientation layer was observed by naked eyes. X was given when the orientation was not observed, and O was given when the orientation was observed even though having a little deviation. The results are illustrated in following Table 1.

TABLE 1

| | | | | Weight | | | |
|---|---|---|---|---|---|---|---|
| | Thickness | | Ratio | ratio | | | |
| | of primer | Water | of UR | of PVA | | | |
| | layer | dispersible | and | to 100 | Base | | Orientation |
| category | (nm) | particles | PVA | of UR | film | adhesiveness | properties |
| Example 1 | 1,000 | Included | 1:1 | 100 | Acryl | ◯ | ◯ |
| | | | | | film | | |
| Example 2 | 500 | Included | 1:1 | 100 | Acryl | ◯ | ◯ |
| | | | | | film | | |
| Example 3 | 200 | Included | 1:1 | 100 | Acryl | ◯ | ◯ |
| | | | | | film | | |
| Example 4 | 1,000 | Included | 1:0.5 | 50 | Acryl | ◯ | ◯ |
| | | | | | film | | |
| Example 5 | 1,000 | Included | 1:0.1 | 10 | Acryl | ◯ | ◯ |
| | | | | | film | | |
| Comparative | 1,000 | Included | 1:0 | 0 | Acryl | ◯ | X |
| example 1 | | | | | film | | |
| Comparative | 1,000 | Included | 0:1 | — | Acryl | X | X |
| example 2 | | | | | film | | |
| Comparative | 1,000 | Included | 1:4 | 400 | Acryl | X | ◯ |
| example 3 | | | | | film | | |

In Table 1, UR is urethane resin, and PVA is polyvinyl alcohol.

While the present invention has been shown and described in connection with the exemplary embodiments, it will be apparent to those skilled in the art that modifications and variations can be made without departing from the spirit and scope of the invention as defined by the appended claims.

What is claimed is:

1. An aqueous primer composition comprising:
100 parts by weight of a urethane resin;
1 to 100 parts by weight of polyvinyl alcohol;
0.1 to 10 parts by weight of water dispersible particles; and
a remainder of water.

2. The aqueous primer composition of claim 1, wherein an amount of a solid content is 1 to 50 parts by weight based on 100 parts by weight of the aqueous primer composition.

3. The aqueous primer composition of claim 1, wherein a weight average molecular weight of the urethane resin is in a range of 10,000 to 200,000.

4. The aqueous primer composition of claim 1, wherein the urethane resin comprises a carboxyl group.

5. The aqueous primer composition of claim 1, wherein the urethane resin is obtained through a reaction of a polyol with an isocyanate.

6. The aqueous primer composition of claim 1, wherein an average molecular weight molecular weight of the polyvinyl alcohol is 2,000 to 40,000.

7. The aqueous primer composition of claim 1, wherein the water dispersible particles are inorganic particles of at least one material selected from the group consisting of silica, titania, alumina, zirconia and antimony.

8. The aqueous primer composition of claim 1, wherein the water dispersible particles are organic particles of at least one material selected from the group consisting of a silicon-based resin, a fluorine-based resin, a (meth)acryl resin, a cross-linked polyvinyl alcohol and a melamine resin.

9. The aqueous primer composition of claim 1, wherein an average diameter of the water dispersible particles is 10 nm to 200 nm.

10. An optical film comprising a primer layer formed by using the aqueous primer composition according to claim 1 on at least one surface of an acryl film.

11. The optical film of claim 10, wherein a thickness of the primer layer is 50 nm to 1,000 nm.

12. The optical film of claim 10, further comprising:
an orientation layer formed on the primer layer; and
a liquid crystal layer formed on the orientation layer.

13. A polarizing plate comprising the optical film according to claim 10.

14. A display device comprising the polarizing plate according to claim 13.
